(19) United States
(12) Patent Application Publication
(10) Pub. No.: US 2008/0111967 A1
(43) Pub. Date: May 15, 2008

(54) Spectacles

(76) Inventor: Graham Anthony Hiew, London (GB)

Correspondence Address: BROOKS KUSHMAN P.C., 1000 TOWN CENTER, TWENTY-SECOND FLOOR, SOUTHFIELD, MI, 48075, US

(21) Appl. No.: 11/573,725

(22) PCT Filed: Jul. 18, 2005
(86) PCT No.: PCT/GB05/02819

§ 371 Date: Feb. 15, 2007

(30) Foreign Application Priority Data
Aug. 24, 2004 (GB) 0418794.4

(51) Int. Cl. G02C 7/16

(52) U.S. Cl. 351/44; 351/120

(57) ABSTRACT

A pair of spectacles comprising: a pair of arms for supporting the spectacles on a wearer's head in use; and a pair of lenses that are tinted, shaded, coloured or reflective; wherein the spectacles are configured such that, when worn in use, when viewed from the front of the wearer's head, the lenses are in front of the wearer's eyes, and when viewed from a side of this wearer's head, the angle between each lens and arm is greater than 90° and unadjustable, such that the bottom of the lens is further from the wearer's head than is the top of the lens. Also provided is a method by which a card player may shield his eyes from competitors whilst enabling himself to view cards close to his person, said method comprising the card prayer: wearing a pair of spectacles comprising: a pair of arms or a strap for supporting the spectacles on the card player's head; and a pair of lenses that are tinted, shaded, coloured or reflective; wherein the spectacles are configured such that, when worn in use, when viewed from the front of the card player's head, the lenses are in front of the card player's eyes, and when viewed from a side of the card player's head, the angle between each lens and arm or strap is greater than 90°, such that the bottom of each lens is further from the card player's head than is the top of the lens; said method further comprising the card player viewing said cards by looking down, between the lenses of the spectacles and the card player's face, rather than through the lenses.

This invention relates to spectacles. The invention is particularly suitable, but by no means limited, for use by gamblers such as poker players.

### BACKGROUND TO THE INVENTION

In live gambling card games such as poker, in which large amounts of money may be at stake, it is extremely important that a player's opponents should not be given any opportunity to see the values or suites of said player's cards. Accordingly, the player is dealt cards face down on a table in such a manner that his opponents cannot see the identities (i.e. values and suites) of the cards that are dealt. Commonly, the player then keeps the cards face down, on or close to the table, and tilts or bends them just sufficiently to enable him to look at the identities of the cards, without letting any of his opponents see the identities of the cards. As those skilled in the art will appreciate, a card protector or cover may also be used to shield the cards from the opponents.

Experienced gamblers are skilled at interpreting the body language and facial responses of an opponent, to ascertain whether the opponent regards his cards as being favourable or not, and thereby to try to gain a tactical advantage over the opponent. Therefore, at the moment when the player first sees the identities of the cards that he has been dealt, it is critical that he should not give his opponents any indication as to whether he regards his cards as being favourable or unfavourable. Since a person's eye movements and facial responses around the eyes can covey a considerable amount of information (some of it subconsciously) when he views his cards, it is common for a gambler to attempt to shield his eyes from his competitors. This may be accomplished by wearing a large brimmed hat such as a Stetson or a baseball cap, and/or by wearing sunglasses. Sunglasses are often used by gamblers, as they enable the gambler to view an opponent's reactions discretely, whilst disguising or shielding his own reactions from the view of others.

The term “sunglasses” as used herein should be interpreted broadly, to refer to any spectacles having tinted, shaded, coloured or reflective lenses which substantially prevent (or at least impede) an onlooker from seeing the wearer's eyes. The term “lenses” should also be interpreted broadly, to include both magnifying and non-magnifying lenses. Additionally, the terms “pair of lenses” or “lenses” as used herein should also be interpreted broadly, to encompass not only two separate lenses (one for each eye) but also a single large lens that is wide enough to cover both eyes.

A problem that is often experienced by gamblers who wear sunglasses is that it can be difficult for the wearer to see the identities of the cards he has been dealt. This problem is exacerbated by the lighting conditions in gambling halls and cardrooms, which are indoors and tend not to have natural light. In some venues subdued lighting may be used. It is very important that the gambler should be able to see the identities of his cards correctly, since mistaking one card for another and playing a card in error could have disastrous consequences on the game. Whilst wearing sunglasses under conditions of subdued lighting, the gambler may find it necessary to lift the cards he has been dealt higher than he would otherwise wish, and in doing so may inadvertently expose his cards to his opponents. To avoid doing this, often a gambler who wears sunglasses resorts to lifting the sunglasses up from in front of his eyes, in order to see the values of the cards he has been dealt. However, this effectively results in the gambler losing the shielding that the sunglasses were intended to provide, and enables his opponents to see his eyes and thereby perceive his reaction to the cards he has been dealt. Additionally, raising the sunglasses with one hand whilst viewing the cards can be cumbersome to do, particularly when the gambler is trying to manipulate his cards in a discrete manner whilst concentrating on the game and endeavouring to keep a straight face or “poker face”. Instead of lifting the sunglasses, the gambler may squint under the bottom of the sunglass lenses, but this is very uncomfortable to the eyes and is prone to lead to eyestrain.

### SUMMARY OF THE INVENTION

According to a first aspect of the present invention there is provided a pair of spectacles comprising: a pair of arms for supporting the spectacles on a wearer's head in use; and a pair of lenses that are tinted, shaded, coloured or reflective; wherein the spectacles are configured such that, when worn in use, when viewed from the front of the wearer's head, the lenses are in front of the wearer's eyes, and when viewed from a side of the wearer's head, the angle (α) between each lens and arm is greater than 90° and unadjustable, such that the bottom of the lens is further from the wearer's head than is the top of the lens.

This configuration of spectacles advantageously enables the gambler to view his cards close to his person, without his view being impeded by the sunglass-type lenses and without having to squint or risk eyestrain, whilst simultaneously shielding his eyes with the sunglass-type lenses so that his opponents are prevented (or at least impeded) from seeing his eyes and thereby cannot readily perceive his reaction when he discovers the identities of his cards.

The lenses of conventional sunglasses are substantially parallel to the wearer's face. This is because the purpose of sunglasses has traditionally been to shield the wearer's eyes from the sun. In recent years there has been a trend in the sunglass industry to make sunglasses which “wrap” around the wearer's face, thereby fitting even closer to the wearer's eyes and improving the shielding from the sun. To create sunglasses having lenses which are in a non-parallel configuration relative to the wearer's face not only goes against this trend, but is also entirely contrary to the traditional design premise that the sunglasses should be configured so as to shield the wearer's eyes from the sun as effectively as possible.

Preferably, when viewed from the side, the angle α between the lens and arm is between 100° and 150° (i.e. the lens is angled between 10° and 60° from the angle of conventional sunglass lenses which are substantially parallel to the wearer's face). More preferably the angle α between the lens and arm is between 110° and 140° (i.e. between 20° and 50° from the conventional position). Even more preferably the angle α between the lens and arm is between 115° and 135° (i.e. between 25° and 45° from the conventional position). These values are merely examples, and the angle α may be any angle that enables the gambler to view his cards close to his person, without his view being impeded by the lenses, whilst simultaneously shielding his eyes from his opponents.

According to a second aspect of the invention there is provided a pair of spectacles comprising: a strap for supporting the spectacles on a wearer's head in use; and a pair of lenses that are tinted, shaded, coloured or reflective; wherein the spectacles are configured such that, when worn in use, when viewed from the front of the wearer's head, the lenses are in front of the wearer's eyes, and when viewed from a side of the wearer's head, the angle α between each lens and the strap is greater than 90° and unadjustable, such that the bottom of the lens is further from the wearer's head than is the top of the lens.

Spectacles in accordance with any of the above aspects of the invention may further comprise shielding members on each side of the spectacles, to prevent (or at least impede) opponents from seeing the gambler's eyes from side-on positions.

According to a third aspect of the invention there is provided a method by which a card player may shield his eyes from competitors whilst enabling himself to view cards close to his person, said method comprising the card player:
wearing a pair of spectacles comprising:
   a pair of arms or a strap for supporting the spectacles on the card player's head; and
   a pair of lenses that are tinted, shaded, coloured or reflective;
   wherein the spectacles are configured such that, when worn in use, when viewed from the front of the card player's head, the lenses are in front of the card player's eyes, and when viewed from a side of the card player's head, the angle between each lens and arm or strap is greater than 90°, such that the bottom of each lens is further from the card player's head than is the top of the lens;
said method further comprising the card player viewing said cards by looking down, between the lenses of the spectacles and the card player's face, rather than through the lenses.

### BRIEF DESCRIPTION OF THE DRAWINGS

Embodiments of the invention will now be described, by way of example only, and with reference to the drawings in which:

FIG. 1 illustrates a side view of a conventional pair of sunglasses being worn, the angle α between the lens and the arm being fixed at an angle of substantially 90°;

FIG. 2 illustrates a side view of a pair of sunglasses in accordance with an embodiment of the invention, the angle α between the lens and the arm being substantially greater than 90°;

FIG. 3 illustrates a side view of a pair of sunglasses in accordance with a prototype, the angle α between the lens and the arm being adjustable; and

FIG. 4 illustrates a side view of the sunglasses of FIG. 3, adjusted such that the angle α between the lens and the arm is that of conventional sunglasses.

In the figures, like elements are indicated by like reference numerals throughout.

### DETAILED DESCRIPTION OF PREFERRED EMBODIMENTS

The present embodiments represent the best ways known to the applicant of putting the invention into practice. However they are not the only ways in which this can be achieved.

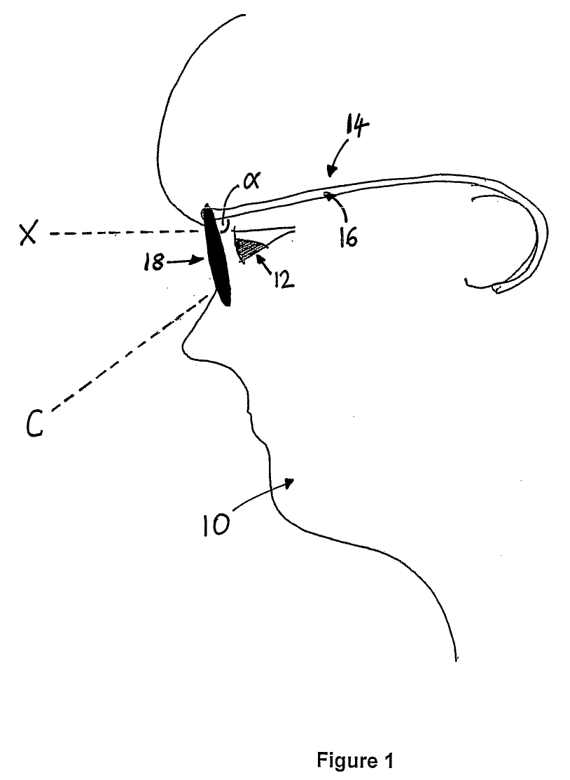

FIG. 1 illustrates a pair of conventional sunglasses 14 being worn by a gambler 10. The sunglasses 14 comprise a pair of arms 16 (only one being visible in the figure due to it being a side view), and a pair of tinted, shaded, coloured or reflective lenses 18 (again only one being visible in this figure). The lens 18 is in front of the wearer's eye 12. The angle α between the arm 16 and the lens 18 is fixed at substantially 90°, so that the lens 18 is substantially parallel to the wearer's face. Whilst the lens 18 prevents (or at least impedes) an opponent situated in direction X from seeing the wearer's eye 12, the lens 18 also impedes the wearer from seeing cards held close to his body, for example in direction C.

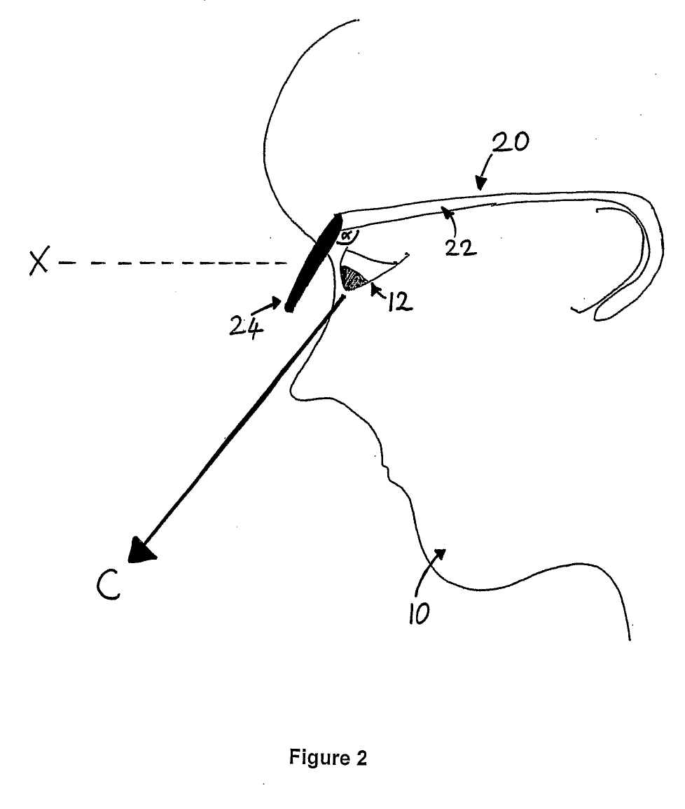

FIG. 2 illustrates an embodiment of the invention. The spectacles 20 comprise a pair of arms 22 and tinted, shaded, coloured or reflective lenses 24. Instead of a pair of arms 22, alternative means by which to support the lenses on the wearer's head may be provided, such as an elasticated or adjustable strap configured to pass around the wearer's head.

The lenses 24 are mounted at an angle α that is substantially greater than 90°. In this embodiment, the lenses are unadjustable with respect to the arms. The angle α is selected such that the gambler is able to look down and view his cards close to his person (e.g. his “hole” cards in poker), for example in direction C, and preferably also the community cards (e.g. the “flop” cards in poker, dealt face up in the middle of the table), without his view being impeded by the lenses. However, the lenses 24 are nevertheless in front of the wearer's eyes (albeit in an inclined configuration) and thereby shield the eyes from an opponent in direction X. The opponent's view of the wearer's eyes 12 is thereby prevented (or at least impeded), so that the opponent cannot perceive the wearer's eye responses when the wearer sees the identities of his cards in direction C.

The angle α may be any angle that enables the gambler to view his cards close to his person, without his view being impeded by the lenses, whilst simultaneously shielding his eyes from his opponents. By way of example, in some variants the angle α could be between 100° and 150° (i.e. the lenses being angled between 10° and 60° from the angle of conventional sunglass lenses (which are at substantially 90° from the arms and are substantially parallel to the wearer's face)). In other variants the angle α may be between approximately 110° and approximately 140° (i.e. between about 20° and about 50° from the conventional position). It is envisaged that in many cases the angle α will be between about 115° and about 135° (i.e. between about 25° and about 45° from the conventional position).

A typical value of the angle α might be approximately 125° (i.e. about 35° from the conventional position), but it should be emphasised that this value is merely an example.

As those skilled in the art will appreciate, the arms 22 may be connected directly to the lenses 24 (optionally via hinges to enable the arms to be folded towards the lenses to facilitate transportation and storage). Alternatively the arms 22 may be connected to a frame (e.g. made of metal, wire or plastic) in which (or onto which) the lenses are mounted. Other components known to those skilled in the art of spectacle design and manufacture may also be provided, such as a nose bridge.

In manufacturing the spectacles 20, the angle α may be formed by incorporating a twist in the frame or arm, near to where the arm 22 meets the lens 24.

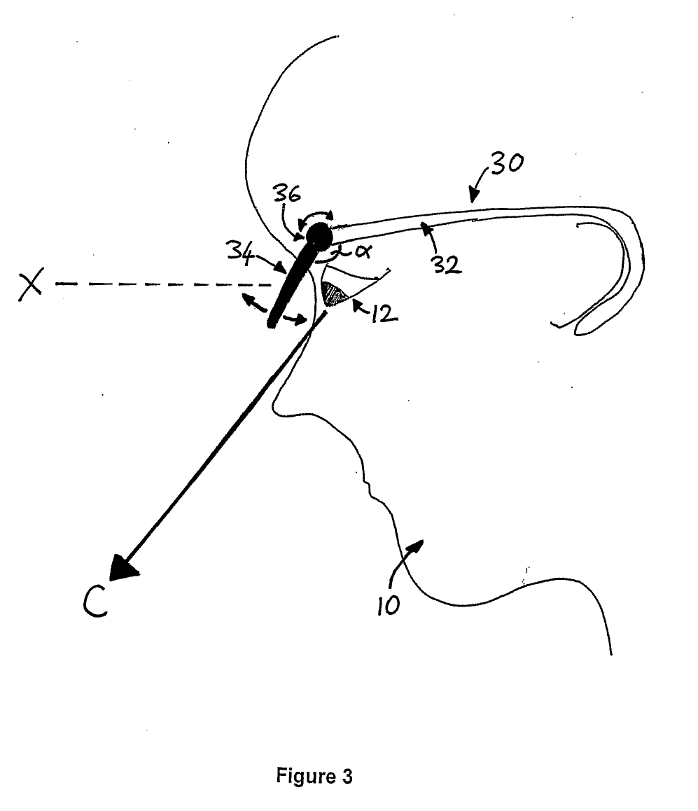

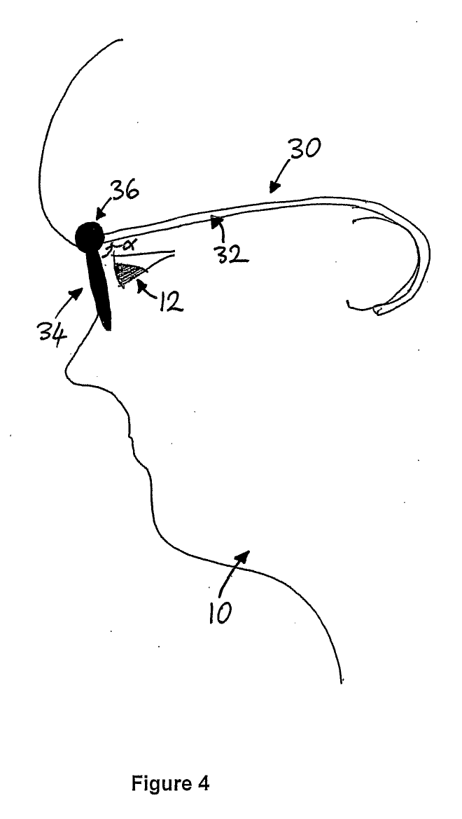

FIGS. 3 and 4 illustrate a prototype of the invention. Here, the spectacles 30 again comprise a pair of arms 32 and tinted, shaded, coloured or reflective lenses 34. As before, instead of a pair of arms 32, alternative means by which to support the lenses on the wearer's head may be provided, such as a strap.

In this prototype, the angle α of each lens 34 is adjustable by means of a manually operable pivot knob 36. As those skilled in the art will appreciate, the lens 34 may be pivotally mounted to the arm 32 or frame of the spectacles, with the lens coupled to the pivot knob 36 so that, when the wearer turns the pivot knob 36, the angle α of the lens is adjusted accordingly. The pivot knob 36 may have a knurled or ridged outer surface to enhance grip between the knob and the user's fingers. The pivot mechanism by which the lenses are adjusted may be effectively infinitely variable, employing gripping or friction means to hold the lens at the angle α as set by the wearer. Alternatively the pivot mechanism may be provided with a plurality of detents to positively retain the lens in any one of a corresponding plurality of angular positions as selected by the wearer.

In this prototype, the lenses may be adjusted through a wide range of angles. For example, the angle α may be adjusted from an angle of substantially 90° (i.e. the angle of conventional sunglass lenses, substantially parallel to the wearer's face) to approximately 150° (i.e. 60° from the position of conventional sunglass lenses).

As shown in FIG. 4, the wearer may set the angle α to approximately 90° so that the spectacles 30 function as conventional sunglasses—for example, to be worn before or after a poker game.

The adjustability of the lenses saves the gambler the inconvenience of having to change spectacles before and after gambling, and also means that he does not need to carry separate “gambling” and “pre/post-gambling” spectacles about his person.

During a poker game, as illustrated in FIG. 3, the wearer may set the angle α as desired, to enable him to view his cards close to his person (e.g. in direction C), without his view being impeded by the lenses, whilst simultaneously shielding his eyes from his opponents (e.g. in direction X).

In the prototype shown in FIGS. 3 and 4, each lens 34 may be provided with its own pivot knob 36, thereby enabling the angle of each lens to be adjusted independently. Alternatively a single pivot knob may be coupled to both lenses to move them simultaneously.

With the various embodiments and prototypes described above, side shields may be provided at the sides of the spectacles. These may be made of opaque material or of a similar material to the sunglass lenses, and serve to prevent (or at least impede) opponents from seeing the gambler's eyes from side-on positions.

The spectacles may also incorporate further side pieces, e.g. a wire frame, and/or regions bearing the name or logo of a manufacturer or sponsor.

Aside from the fixed angled or adjustable angled lenses, the embodiments and prototypes may take the general design of any pair of sunglasses or spectacles, including (but by no means limited to) any of the styles listed below:

Aviator Sunglasses
Baseball Sunglasses
Cycling Sunglasses
Driving Sunglasses
Fishing Sunglasses
Glacier Glasses
Golf Sunglasses
Motorcycle Goggles
Shooting Sunglasses
Ski Goggles
Tennis Sunglasses
Water Sports Sunglasses

### SUMMARY

A pair of spectacles has been described which are designed to shield a gambler's eyes using a shaded lens (similar to sunglasses), but which enable the gambler to see (in the example of poker) his hole cards and flop cards directly with his eyes and not through the shaded lens.

1. A pair of spectacles comprising:
a pair of arms for supporting the spectacles on a wearer's head in use;
and
a pair of lenses that are tinted, shaded, coloured or reflective;
wherein the spectacles are configured such that, when worn in use, when viewed from the front of the wearer's head, the lenses are in front of the wearer's eyes, and when viewed from a side of the wearer's head, the angle between each lens and arm is greater than 90° and unadjustable, such that the bottom of the lens is further from the wearer's head than is the top of the lens.

2. A pair of spectacles as claimed in claim 1 wherein, when viewed from the side, the angle between the lens and arm is between 100° and 150°.

3. A pair of spectacles as claimed in claim 2 wherein, when viewed from the side, the angle between the lens and arm is between 110° and 140°.

4. A pair of spectacles as claimed in claim 3 wherein, when viewed from the side, the angle between the lens and arm is between 115° and 135°.

5. A pair of spectacles comprising:
a strap for supporting the spectacles on a wearer's head in use; and
a pair of lenses that are tinted, shaded, coloured or reflective;
wherein the spectacles are configured such that, when worn in use, when viewed from the front of the wearer's head, the lenses are in front of the wearer's eyes, and when viewed from a side of the viewer's head, the angle between each lens and the strap is greater than 90° and unadjustable, such that the bottom of the lens is further from the wearer's head than is the top of the lens.

6. A pair of spectacles as claimed in claim 1, further comprising shielding members on each side of the spectacles.

7. A method by which a card player may shield his eyes from competitors whilst enabling himself to view cards close to his person, said method comprising the card player:
wearing a pair of spectacles comprising:
a pair of arms or a strap for supporting the spectacles on the card player's head; and
a pair of lenses that are tinted, shaded, coloured or reflective;
wherein the spectacles are configured such that, when worn in use, when viewed from the front of the card player's head, the lenses are in front of the card player's eyes, and when viewed from a side of the card player's head, the angle between each lens and arm or strap is greater than 90°, such that the bottom of each lens is further from the card player's head than is the top of the lens;
said method further comprising the card player viewing said cards by looking down, between the lenses of the spectacles and the card player's face, rather than through the lenses.

8. (canceled)

9. (Canceled)

10. A pair of spectacles as claimed in claim 2, further comprising shielding members on each side of the spectacles.

11. A pair of spectacles as claimed in claim 3, further comprising shielding members on each side of the spectacles.

12. A pair of spectacles as claimed in claim 4, further comprising shielding members on each side of the spectacles.

13. A pair of spectacles as claimed in claim 5, further comprising shielding members on each side of the spectacles.
